(19) United States
(12) Patent Application Publication
(10) Pub. No.: US 2023/0392516 A1
(43) Pub. Date: Dec. 7, 2023

(54) WATER QUALITY DIAGNOSIS METHOD

(71) Applicant: MITSUBISHI HEAVY INDUSTRIES, LTD., Tokyo (JP)

(72) Inventors: Akihiro HAMASAKI, Kanagawa (JP); Haruka KIDO, Kanagawa (JP); Taro ICHIHARA, Kanagawa (JP); Tetsuya SAWATSUBASHI, Tokyo (JP); Yuta NAKATSUCHI, Tokyo (JP)

(21) Appl. No.: 18/032,633

(22) PCT Filed: Jan. 25, 2022
(86) PCT No.: PCT/JP2022/002558

§ 371 Date: Apr. 19, 2023

(30) Foreign Application Priority Data
Jan. 28, 2021 (JP) 2021-011639

(51) Int. Cl. F01D 25/00; F01D 21/00; C02F 1/66

(52) U.S. Cl. CPC F01D 25/007; F01D 21/003; C02F 1/66; F05D 2260/95; F05D 2220/31; C02F 2209/06; C02F 2303/08; C02F 2209/05

(57) ABSTRACT

A water quality diagnosis method, includes: a step of obtaining a measurement value of electrical conductivity of a sample water derived from a steam or a circulating water obtained from a steam turbine plant using ammonia as a water conditioner and a measurement value of pH of the sample water; and a determination step of determining presence or absence of abnormality of water quality of the steam turbine plant by using at least a first determination condition of whether the measurement value of the electrical conductivity and the measurement value of the pH are included in a first determination region which is set within a first correlation map of the electrical conductivity and the pH taking into account a carbonic acid concentration range where carbonic acid is dissolvable in the sample water.

### TECHNICAL FIELD

The present disclosure relates to a water quality diagnosis method.

The present application claims priority based on Japanese Patent Application No. 2021-011639 filed on Jan. 28, 2021 with the Japanese Patent Office, the contents of which are incorporated herein by reference.

### BACKGROUND ART

In a steam turbine plant, it is required to diagnose the water quality of circulating water and steam in order to suppress corrosion or the like of devices and pipes constituting the water circulation system including a boiler and a turbine.

Patent Document 1 discloses a water quality diagnosis method for a power generation plant that uses ammonia as a water conditioner for suppressing corrosion of devices. The method described in Patent Document 1 firstly obtains a reference value from a correlation between the pH and the electrical conductivity corresponding to the ammonia concentration. Then, the method measures the pH and the electrical conductivity of circulating water of the power generation plant, and determines the degree of water quality abnormality of the circulating water on the basis on the magnitude of the difference between the measurement value and the reference value.

Although not related to water quality diagnosis, Patent Document 2 discloses controlling an ammonia injection pump on the basis of the measurement value of the electrical conductivity such that the pH of the plant circulating water remains within a predetermined range, using a correlation between the pH and the electrical conductivity taking account of a carbonic acid gas concentration.

### CITATION LIST

### Patent Literature

Patent Document 1: JP2019-95232A
Patent Document 2: JPS61-268905A

### SUMMARY

### Problems to be Solved

Meanwhile, in a steam turbine plant, the water quality of circulating water or steam (hereinafter, referred to as circulating water or the like) may change due to incorporation of acid, alkali, or salt from outside, and such a change in the water quality may also cause change in the electrical conductivity and the pH of the circulating water or the like. Thus, it is possible to detect water quality abnormality due to incorporation of such substances as described above, on the basis of measurement values of the electrical conductivity and the pH. Meanwhile, the correlation between the electrical conductivity and the pH of the circulating water or the like is under influence of the carbonic acid concentration in the water. The carbonic acid concentration in the circulating water or the like corresponds to the amount of carbon dioxide in atmosphere dissolved into the circulating water or the like, and thus may change depending on the operation state or the like of the plant.

In this regard, the method described in Patent Document 1 does not take into account the carbonic acid concentration in the circulation water, and thus the result of water quality diagnosis may not always be appropriate.

In view of the above, an object of at least one embodiment of the present invention is to provide a water quality diagnosis method capable of determining presence or absence of water quality abnormality of a steam turbine plant more appropriately.

### Solution to the Problems

According to at least one embodiment of the present invention, a water quality diagnosis method includes: a step of obtaining a measurement value of electrical conductivity of a sample water derived from a steam or a circulating water obtained from a steam turbine plant using ammonia as a water conditioner and a measurement value of pH of the sample water; and a determination step of determining presence or absence of abnormality of water quality of the steam turbine plant by using at least a first determination condition of whether the measurement value of the electrical conductivity and the measurement value of the pH are included in a first determination region which is set within a first correlation map of the electrical conductivity and the pH taking into account a carbonic acid concentration range where carbonic acid is dissolvable in the sample water.

### Advantageous Effects

According to at least one embodiment of the present invention, it is possible to provide a water quality diagnosis method capable of determining presence or absence of water quality abnormality of a steam turbine plant more appropriately.

### BRIEF DESCRIPTION OF DRAWINGS

FIG. 1 is a schematic configuration diagram of a steam turbine plant to which the water quality diagnosis method according to some embodiments is to be applied.

FIG. 2 is a schematic diagram showing the configuration of a measurement part for measuring the water quality parameter of sample water.

FIG. 3 is a diagram showing an example of the first correlation map used in the water quality diagnosis method according to an embodiment.

FIG. 4 is a diagram showing an example of the second correlation map used in the water quality diagnosis method according to an embodiment.

FIG. 5 is a flowchart of a water quality diagnosis method according to an embodiment.

FIG. 6 is a flowchart of a water quality diagnosis method according to an embodiment.

### DETAILED DESCRIPTION

Embodiments of the present invention will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

(Configuration of Steam Turbine Plant)

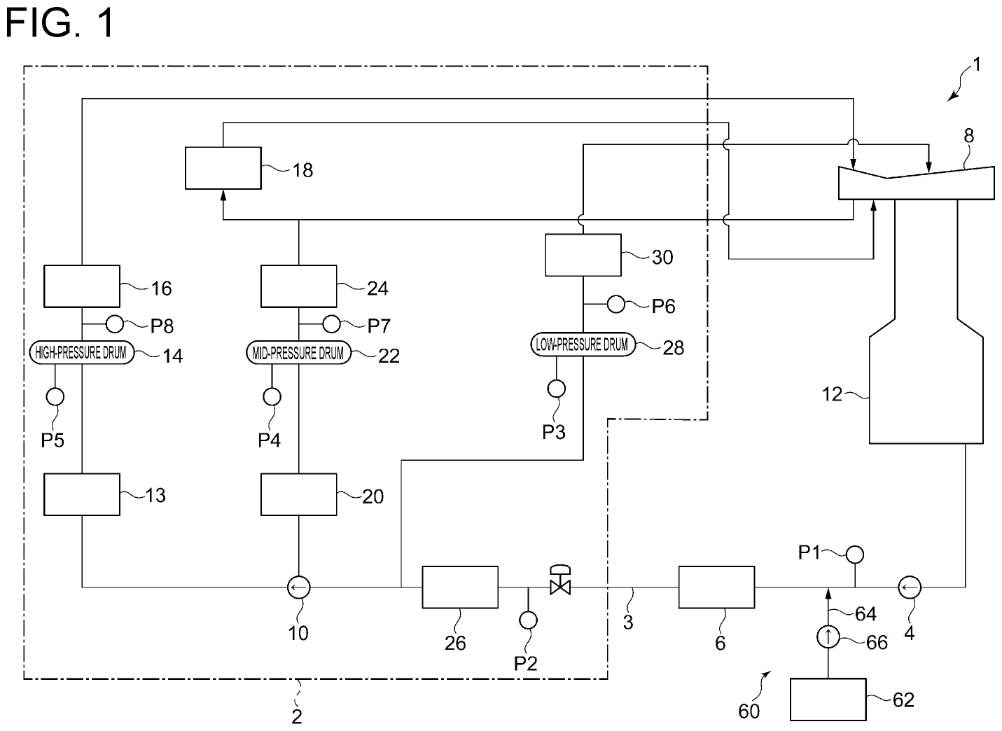

FIG. 1 is a schematic configuration diagram of a steam turbine plant to which the water quality diagnosis method according to some embodiments is to be applied. As depicted in FIG. 1, the steam turbine plant 1 includes a boiler 2 for generating steam, and a steam turbine 8 configured to be driven by the steam from the boiler 2. The steam turbine 8 may be configured to drive a generator. The boiler 2 may be an exhaust heat recovery boiler (heat recovery steam generator) configured to be supplied with exhaust gas from a gas turbine.

The boiler 2 includes steam drums (14, 22, 28) including a high-pressure drum 14, a mid-pressure drum 22, and a low-pressure drum 28, economizers (a high-pressure economizer 13, a mid-pressure economizer 20, and a low-pressure economizer 26) provided corresponding to the respective steam drums (14, 22, 28), an evaporator (not depicted), superheaters (a high-pressure superheater 16, a mid-pressure superheater 24, and a low-pressure superheater 30), and a reheater 18. During operation of the steam turbine plant 1, among the steam drums, the high-pressure drum 14 has the highest internal pressure, the mid-pressure drum 22 the second, and the low-pressure drum 28 has the lowest internal pressure.

The economizers (13, 20, 26) are configured to heat feed water supplied from the feed water line 3 through heat exchange with exhaust gas or the like. The feed water heated by the economizers (13, 20, 26) is respectively guided to the steam drums (14, 22, 28) corresponding to the respective economizers.

Evaporators corresponding to the respective steam drums (14, 22, 28) are connected to the steam drums (14, 22, 28) via a downcomer tube (not depicted) and an evaporation tube (not depicted), respectively. The feed water inside the steam drums (14, 22, 28) is guided to the evaporators via the downcomer tube.

The evaporator is configured to generate steam by evaporating feed water through heat exchange with exhaust gas or the like. The steam generated by the evaporator flows into the steam drums (14, 22, 28) via the evaporation pipe together with the feed water (that is, in the form of two-phase flow). The steam and the feed water are separated by a gas-liquid separator (not depicted) at the steam drums (14, 22, 28), and the accordingly separated steam is stored temporarily as saturated steam in the steam drums (14, 22, 28). The saturated steam inside the steam drums (14, 22, 28) is guided to the superheaters (16, 24, 30) corresponding to the respective steam drums (14, 22, 28), respectively.

The superheaters (16, 24, 30) and the reheater 18 are configured to heat steam from the steam drums (14, 22, 28) through heat exchange with exhaust gas or the like. The steam heated by the superheaters (16, 24, 30) and the reheater 18 is guided to the steam turbine 8 and rotary drives the steam turbine 8.

The steam from the steam drums (14, 22, 28) is heated by the superheaters (16, 24, corresponding to the respective steam drums, and then introduced to the high-pressure turbine part, the mid-pressure turbine part, and the low-pressure turbine part of the steam turbine 8. The steam after passing the high-pressure turbine part is merged with the steam from the mid-pressure superheater 24, guided to the reheater 18, reheated by the reheater 18, and then introduced to the mid-pressure turbine part of the steam turbine 8. The steam after passing the mid-pressure turbine part is merged with the steam from the low-pressure superheater 30, and introduced to the low-pressure turbine part of the steam turbine 8.

The steam after passing the low-pressure turbine part of the steam turbine 8 is guided to the condenser 12 connected to the low-pressure turbine part and condensed by the condenser 12, and the condensed water is supplied to the respective steam drums (14, 22, 28) via the feed water line 3 and the feed water pump 4 as feed water.

In the illustrative embodiment depicted in FIG. 1, a high-mid-pressure feed water pump 10 is disposed at the downstream side of the low-pressure economizer 26 on the feed water line 3, and the feed water pressurized by the high-mid-pressure feed water pump 10 is supplied to the mid-pressure drum 22 and the high-pressure drum 14.

Furthermore, in the illustrative embodiment depicted in FIG. 1, a grand steam condenser 6 for condensing grand steam is disposed at the downstream side of the feed water pump 4 and at the upstream side of the low-pressure economizer 26 on the feed water line 3.

The steam turbine plant 1 depicted in FIG. 1 includes an agent supply part 60 for supplying ammonia as a water conditioner (agent) to the feed water of the feed water line 3. The agent supply part 60 includes an agent tank 62, an agent line 64 disposed between the agent tank 62 and the feed water line 3, and an agent pump 66 disposed on the agent line 64.

The agent line 64 is connected to the feed water line 3 at a position at the downstream side of the condenser 12 and at the upstream side of the low-pressure economizer 26. Thus, feed water mixed with the water conditioner from the agent tank 62 and the agent line 64 is supplied to the low-pressure drum 28, the mid-pressure drum 22, and the high-pressure drum 14 via the feed water line 3. In the illustrative embodiment depicted in FIG. 1, the agent line 64 is connected to the feed water line 3 at a position at the downstream side of the condenser 12 and at the upstream side of the grand steam condenser 6.

As a water conditioner, ammonia is supplied to the feed water in order to suppress corrosion of devices (e.g., economizers (13, 20, 26), steam drums (14, 22, 28), or the like) that contact with the circulating water such as the feed water or steam. The water conditioner may have, for instance, a function as a pH adjuster capable of adjusting pH of the feed water so as to suppress corrosion which is likely to occur when pH of the feed water is within a predetermined range.

The steam turbine plant to which the water quality diagnosis method according to an embodiment of the present invention is to be applied is not limited to the steam turbine plant 1 including the exhaust heat recovery boiler, and may be, for instance, a steam turbine plant configured to drive a steam turbine with steam generated by a boiler which combusts a fuel such as coal, petroleum, liquefied natural gas, heavy fuel, or the like.

(Configuration of Measurement Part)

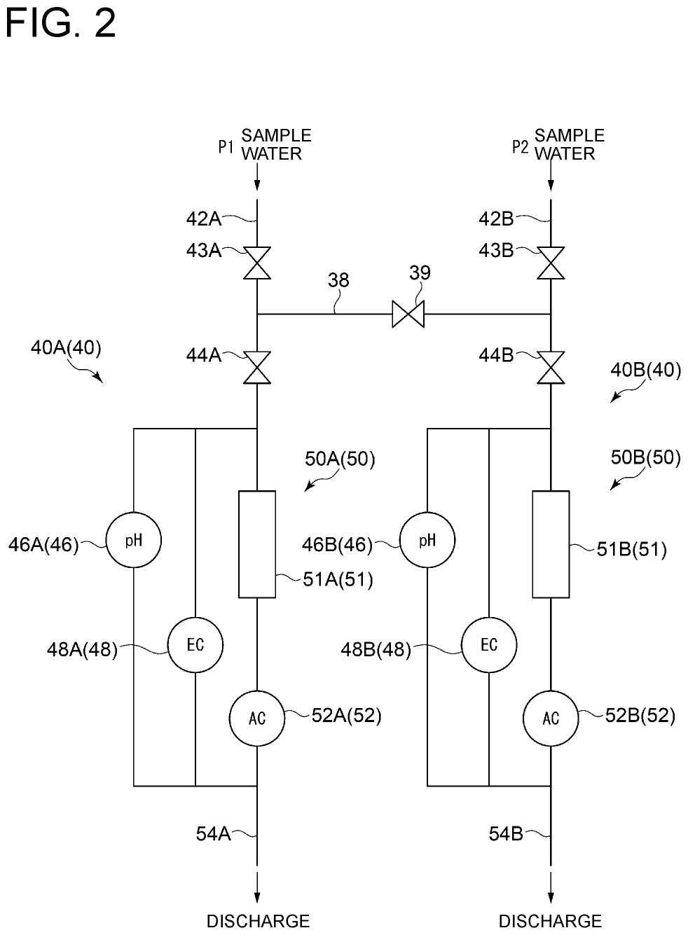

FIG. 2 is a schematic diagram showing the configuration of a measurement part for measuring the water quality parameter of sample water obtained from the steam turbine plant 1. In the water quality diagnosis method according to some embodiments, a water quality parameter of sample water obtained from the circulating water such as feed water or steam (hereinafter, also referred to as the circulating water or the like) of the steam turbine plant 1 is measured by the measurement part 40 (40A, 40B), and presence or absence of abnormality of water quality of the circulating water or the like is determined on the basis of the measurement value. Herein, the water quality parameter includes pH, electrical conductivity, or acid electrical conductivity.

As depicted in FIG. 1, the obtaining point of sample water in the steam turbine plant 1 may be, for instance, the condenser pump outlet P1, the low-pressure economizer inlet P2, the low-pressure steam drum P3, the mid-pressure steam drum P4, the high-pressure steam drum P5, the low-pressure steam drum outlet P6, the mid-pressure steam drum outlet P7, or the high-pressure steam drum outlet P8.

The sample water may be obtained from the feed water at the condenser pump outlet P1, the feed water at the low-pressure economizer inlet P2, the drum water at the low-pressure steam drum P3, the drum water at the mid-pressure steam drum P4, the drum water at the high-pressure steam drum P5, the steam at the low-pressure steam drum outlet P6, the steam at the mid-pressure steam drum outlet P7, or the steam at the high-pressure steam drum outlet P8.

A plurality of measurement parts 40 for measuring the water quality parameter may be provided corresponding to the above described obtaining points P1 to P8, respectively. Alternatively, a single measurement part 40 may be provided for two or more of the obtaining points P1 to P8. That is, a measurement part 40 may be configured to be capable of measuring the water quality parameter of sample water from a plurality of obtaining points P1 to P8. FIG. 2 shows, as an example, a measurement part 40A for measuring the water quality parameter of feed water (sample water) from the condenser pump outlet P1, and a measurement part 40B for measuring the water quality parameter of the feed water (sample water) at the low-pressure economizer inlet P2.

The measurement part 40 (40A, 40B) includes a pH meter 46 (46A, 46B) for measuring the pH of the sample water, an electrical conductivity meter 48 for measuring the electrical conductivity of the sample water, and/or an acid electrical conductivity meter 50 (50A, 50B) for measuring the acid electrical conductivity of the sample water. Herein, acid electrical conductivity refers to electrical conductivity measured after exchanging cations in the sample water to hydrogen ions.

The acid electrical conductivity meter 50 (50A, 50B) includes an ion exchange part 51 (51A, 51B) for exchanging cations in the sample water to hydrogen ions and an electrical conductivity meter 52 (52A, 52B) for measuring the electrical conductivity of the sample water after passing the ion exchange part 51. The ion exchange part 51 may include an ion exchange resin or an electrical ion exchanger.

The measurement part 40 (40A, 40B) is supplied with the sample water from each obtaining point (the condenser pump outlet P1 or the low-pressure economizer inlet P2 in FIG. 2) via a sample water feed line 42 (42A, 42B). The sample water from the sample water feed line 42 is divided and supplied to each of the respective measurement instruments (the pH meter 46, the electrical conductivity meter 48, or the acid electrical conductivity 50).

In the example depicted in FIG. 2, the sample water obtained from the condenser pump outlet P1 is supplied to the measurement part 40A via the sample water feed line 42A, and the sample water obtained from the low-pressure economizer inlet P2 is supplied to the measurement part 40B via the sample water feed line 42B.

In a case where the water quality diagnosis target is steam (e.g., steam at the low-pressure steam drum outlet P6, the mid-pressure steam drum outlet P7, or the high-pressure steam drum outlet P8), the steam maybe condensed with a condenser (not depicted), and the condensed water obtained accordingly may be supplied to the measurement part 40 as the sample water. Furthermore, the sample water from drum water (e.g., the low-pressure steam drum P3, the mid-pressure steam drum P4, or the high-pressure steam drum P5) may be cooled to an ordinary temperature and an ordinary pressure with a cooler (not depicted) and supplied to the measurement part 40.

The sample water after passing through the measurement part 40 (40A, 40B) is discharged via a sample water discharge line 54 (54A,54B).

As depicted in FIG. 2, the sample water feed lines 42 (42A and 42B) corresponding to the measurement parts 40 of a plurality of systems (i.e., the measurement parts 40A and 40B) may be connected to one another via a connection line 38. In this case, a valve 39 is disposed on the connection line 38, and a valve 43 (43A, 43B) and a valve 44 (44A, 44B) are disposed at the upstream side and the downstream side of the connection point of each sample water feed line 42 (42A, 42B) to the connection line 38. Accordingly, by appropriately operating opening and closing of the valve 39, the valve 43, and the valve 44, it is possible to switch the flow of sample water such that the sample water obtained at a certain obtaining point is supplied to the corresponding measurement part 40 (e.g., the measurement parts 40A and 40B) of the plurality of systems.

For instance, in the example depicted in FIG. 2, to supply the sample water from the condenser pump outlet P1 to the measurement part 40A and the sample water from the low-pressure economizer inlet P2 to the measurement part 40B, the valves 43A, 44A, 43B, and 44B are opened, and the valve 39 is closed. Furthermore, to supply the sample water from the condenser pump outlet P1 to both of the measurement parts 40A and 40B, the valves 43A, 44A, 44B, and 39 are opened, and the valve 43B is closed. Moreover, to supply the sample water from the low-pressure economizer inlet P2 to both of the measurement parts and 40B, the valves 43B, 44B, 44A, and 39 are opened, and the valve 43A is closed.

(Flow of Water Quality Diagnosis)

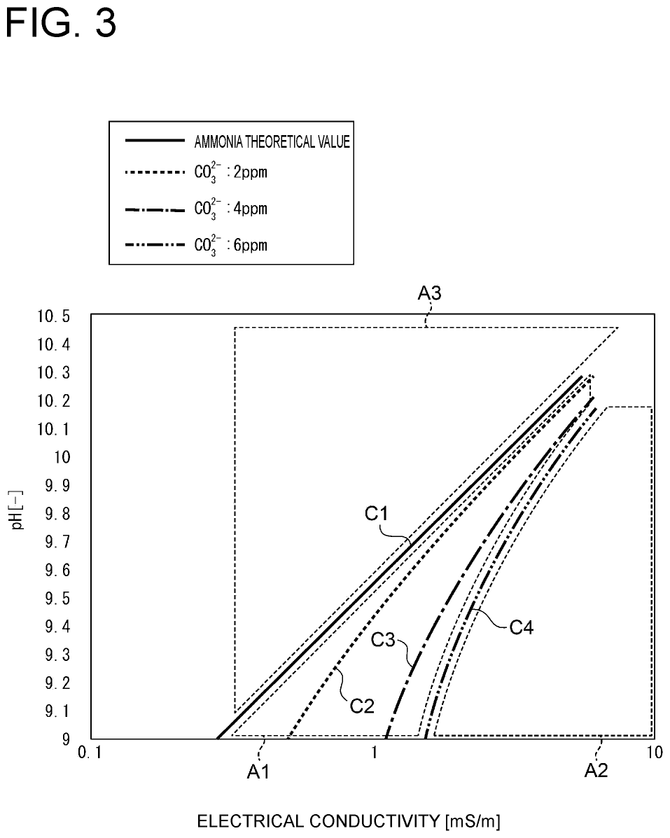

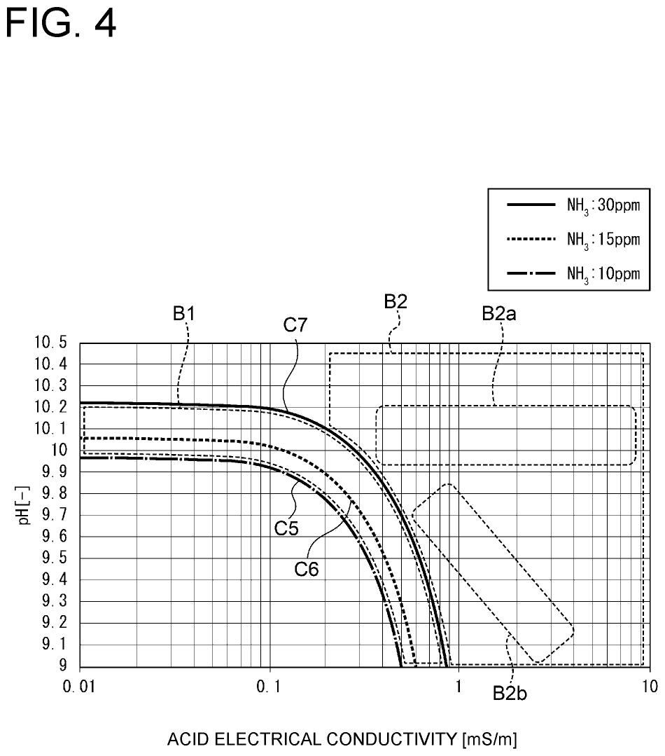

Hereinafter, the flow of water quality diagnosis according to some embodiments will be described. FIG. 3 is a diagram showing an example of the first correlation map used in the water quality diagnosis method according to an embodiment. FIG. 4 is a diagram showing an example of the second correlation map used in the water quality diagnosis according to an embodiment.

In the water quality diagnosis method according to some embodiments, the first correlation map (see FIG. 3) showing the correlation between the electrical conductivity and the pH of sample water is used to perform water quality diagnosis of circulating water or the like. In the present embodiment, the method includes obtaining the measurement value of the electrical conductivity and the measurement value of the pH of the sample water (e.g., sample water obtained from the circulating water or steam at one of the above described obtaining points P1 to P8) derived from steam or circulating water obtained from a steam turbine plant (e.g., the above described steam turbine plant 1) that uses ammonia as a water conditioner. It is possible to obtain the measurement value of the electrical conductivity and the measurement value of the pH of the sample water by, for instance, using the electrical conductivity meter 48 and the pH meter 46 of the measurement part 40 described above, for instance.

Next, presence or absence of abnormality of water quality of the steam turbine plant is determined, at least using the first determination condition of whether the measurement value of the electrical conductivity and the measurement value of the pH are included in the first determination region which is set within the first correlation map taking into account the carbonic acid concentration range where carbonic acid is dissolvable in the sample water.

In the present specification, the carbonic acid concentration refers to the total concentration of carbonic acid (H₂CO₃), hydrogencarbonate ions (HCO₃⁻), and carbonate ions (CO₃²⁻) dissolved in water, that is, the total carbonic acid concentration. It should be noted that, in a steady state, the ratio of carbonic acid (H₂CO₃), hydrogencarbonate ions (HCO₃⁻), and carbonate ions (CO₃²⁻) that dissolve in water is a predetermined ratio corresponding to the pH. Thus, if the concentration of one of carbonic acid (H₂CO₃), hydrogencarbonate ions (HCO₃⁻), or carbonate ions (CO₃²⁻), and the pH are known, it is possible to calculate the total carbonic acid concentration in water.

Now, the first correlation map and the first determination region will be described referring to FIG. 3. The first correlation map is a known map divided as a region where the combination of the electrical conductivity and the pH may exist, in relation to the state of water quality of the sample water obtained from the steam turbine plant. It is possible to determine the state of water quality depending on the region to which the measurement value of the electrical conductivity and the measurement value of the pH belong on the first correlation map.

In the graph shown in FIG. 3, curves C1 to C4 each indicates a correlation of the electrical conductivity (x-axis) and the pH (y-axis) corresponding to the carbonic acid concentration of sample water containing ammonia. Specifically, curves C1 to C4 each indicates the correlation of the electrical conductivity and the pH when the concentration of carbonic acid ions (CO₃²⁻) in the sample water (described as “ammonia theoretical value” in FIG. 3) is 0 ppm, 2 ppm, 4 ppm, and 6 ppm, respectively.

The correlations of the electrical conductivity and the pH corresponding to the carbonic acid concentration (e.g., the relationship indicated by curves C1 to C4 in FIG. 3) are obtained in advance by an experimental method or calculation. In a case of an experimental method, it is possible to obtain the above described correlations by measuring the electrical conductivity and the pH under various ammonia concentrations and carbonic acid concentrations using circulating water in a case where the water quality is normal. In a case of calculation, it is possible to use chemical equilibrium computation to calculate the ammonia concentration and the carbonic acid ion concentration on the basis of acid dissociation equilibrium, alkali dissociation equilibrium, water dissociation equilibrium, balance of positive and negative electric charges, and mass balance of acid and alkali, and then calculate the pH and the electrical conductivity from each of the calculated concentrations.

While the electrical conductivity and the pH of the sample water vary depending on the ammonia concentration of the sample water (circulating water or the like), the relationship between the electrical conductivity and the pH follows the correlations indicated by curves C1 to C4. For instance, in a case where the concentration of carbonic acid ions (CO₃²⁻) in the sample water is 0 ppm, while the electrical conductivity and the pH of the sample water vary depending on the ammonia concentration in the sample water, the relationship between the electrical conductivity and the pH follows curve C1. It should be noted that the electrical conductivity and the pH tend to increase as the ammonia concentration in the sample water increases.

Herein, the carbonic acid concentration in the sample water (circulating water or the like) corresponds to the amount of carbon dioxide (CO₂) in the atmosphere dissolved in the circulating water or the like, and thus may change depending on the operation state or the like of the steam turbine plant. For instance, during operation of the steam turbine plant, the degree of vacuum of the condenser is high, and thus the carbonic acid concentration in the feed water and the sample water becomes low. Meanwhile, if vacuum of the condenser breaks when the steam turbine plant is shutdown, for instance, carbon dioxide in the atmosphere dissolves into the feed water, and thus the carbonic acid concentration in the feed water and the sample water becomes high.

Furthermore, the carbonic acid ion concentration in the sample water (circulating water or the like) is within the range of not smaller than 0 ppm and not greater than approximately 6 ppm. This is because the upper limit value of the carbonic acid ion concentration in a case where the carbon dioxide (CO₂) in the atmosphere dissolves into water is approximately 6 ppm. Accordingly, the boundary indicating the relationship of the electrical conductivity and the pH in a case where the carbonic acid concentration in the sample water (circulating water or the like) is zero is indicated by curve C1, and the boundary indicating the relationship of the electrical conductivity and the pH in a case where the carbonic acid concentration in the sample water (circulating water or the like) is at an upper limit where carbonic acid is dissolvable is shown by curve C4. That is, in FIG. 3, the region between curves C1 and C4 is a region where the combination of the electrical conductivity and the pH may exist when there is no water quality abnormality of the sample water (when there is no incorporation of impurity substances or the like).

Thus, by using the above described curves C1 to C4 or the like for instance, it is possible to set a region for water quality abnormality determination (the above described first determination region) within the first correlation map, taking into account the carbonic acid concentration range where carbonic acid is dissolvable in the sample water.

In a steam turbine plant, the water quality of circulating water or steam (circulating water or the like) may change due to incorporation of acid, alkali, or salt from outside. For instance, the water quality may vary due to incorporation or the like of an additive agent (e.g., a rust proof agent) added for stable operation of a steam turbine plant, or acid or salt from outside (e.g., NaCl due to sea water leakage at a condenser). Such a change in the water quality may also cause change in the electrical conductivity and the pH of circulating water or the like. Thus, it is possible to detect water quality abnormality due to incorporation of the above described substances on the basis of the measurement value of the electrical conductivity and the measurement value of the pH. Meanwhile, as described above, the correlation between the electrical conductivity and the pH of the circulating water or the like is under influence of the carbonic acid concentration in the water. The carbonic acid concentration of circulating water or the like corresponds to the amount of carbon dioxide in atmosphere dissolved in the circulating water or the like, and thus may change depending on the operation state or the like of the plant.

In this regard, in the water quality diagnosis method according to the above described embodiment, presence or absence of abnormality of the water quality of the sample water (circulating water or the like) is determined on the basis of the first determination condition of whether the measurement value of the electrical conductivity and the measurement value of the pH are included in the first determination region which is set within the first correlation map of the electrical conductivity and the pH taking into account a carbonic acid concentration at which carbonic acid is dissolvable in the sample water (circulating water or the like). Thus, it is possible to diagnose the water quality appropriately even if the carbonic acid concentration in the sample water varies depending on the operation state or the like of the plant.

For instance, on the first correlation map shown in FIG. 3, the region A1 (see FIG. 3) between the boundary (curve C1) indicating the relationship of the electrical conductivity and the pH in a case where the carbonic acid concentration in the sample water is zero and the boundary (curve C4) indicating the relationship of the electrical conductivity and the pH in a case where the carbonic acid concentration is at an upper limit where carbonic acid is dissolvable in the sample water may be set as the first determination region. In this case, it may be determined that the water quality is normal if the measurement value of the electrical conductivity and the measurement value of the pH of the sample water are included in the region A1, and that the water quality is abnormal if it is not the case.

Alternatively, on the first correlation map, the region A2 (see FIG. 3) at an opposite side to the above described region A1 across the boundary (curve C4) indicating the relationship of the electrical conductivity and the pH in a case where the carbonic acid concentration is at an upper limit where carbonic acid is dissolvable in the sample water may be set as the first determination region. In this case, for instance, it may be determined that the water quality is abnormal if the measurement value of the electrical conductivity and the measurement value of the pH of the sample water are included in the region A2.

Alternatively, on the first correlation map, the region A3 (see FIG. 3) positioned at an opposite side to the above described region A1 across the boundary (curve C1) indicating the relationship of the electrical conductivity and the pH in a case where the carbonic acid concentration is zero may be set as the first determination region. In this case, for instance, it may be determined that the water quality is abnormal if the measurement value of the electrical conductivity and the measurement value of the pH of the sample water are included in the region A3.

In some embodiments, presence or absence of abnormality of the water quality of the steam turbine plant is determined on the basis of whether the measurement value of the electrical conductivity and the measurement value of the pH of the sample water are included in the above described region A1 (the first normal region) as the first determination region on the first correlation map.

The region A1 is a region between the boundary (curve C1) indicating the relationship of the electrical conductivity and the pH in a case where the carbonic acid concentration in the sample water is zero and the boundary (curve C4) indicating the relationship of the electrical conductivity and the pH in a case where the carbonic acid concentration in the sample water is at the upper limit. Thus, if there is no acid, salt, or alkali incorporated into the circulating water or the like other than carbonic acid, the measurement value of the electrical conductivity and the measurement value of the pH of the sample water should be included in the region A1 on the first correlation map. Thus, it is possible to determine presence or absence of abnormality of the water quality appropriately on the basis of whether the measurement value of the electrical conductivity and the measurement value of the pH are included in the region A1 (the first normal region).

In an embodiment, it is determined that abnormality of the water quality due to incorporation of acid or salt other than carbonic acid to the sample water is present if, on the first correlation map, the measurement value of the electrical conductivity and the measurement value of the pH are included in a region A2 positioned at an opposite side to the region A1 (the first normal region) as the first determination region across the boundary (curve C4) indicating the relationship of the electrical conductivity and the pH in a case where the carbonic acid concentration is at the upper limit where carbonic acid is dissolvable in the sample water.

If acid or salt is incorporated in the circulating water or the like of a steam turbine plant, the pH tends to decrease or the electrical conductivity tends to increase compared to when it is not the case. In this regard, according to the above described embodiment, it is possible to identify the cause of water quality abnormality if the measurement value of the electrical conductivity and the measurement value of the pH are included in the region A2 at an opposite side to the region A1 (the first normal region) across the boundary (curve C4) indicating the relationship of the electrical conductivity and the pH in a case where the carbonic acid concentration is at the upper limit. Specifically, it is possible to determine that the water quality abnormality in this case is caused by incorporation of acid or salt other than carbonic acid to the sample water.

In an embodiment, it is determined that abnormality of the water quality due to incorporation of a basic substance other than ammonia is present if, on the first correlation map, the measurement value of the electrical conductivity and the measurement value of the pH of the sample water are included in the region A3 positioned at an opposite side to the region A1 (the first normal region) as the first determination region across the boundary (curve C1) indicating the relationship of the electrical conductivity and the pH in a case where the carbonic acid concentration is zero.

If a basic substance is incorporated in a steam turbine plant, the pH tends to increase compared to when it is not the case. In this regard, according to the above described embodiment, it is possible to identify the cause of water quality abnormality if the measurement value of the electrical conductivity and the measurement value of the pH are included in the region A3 at an opposite side to the region A1 (the first normal region) across the boundary (curve C1) indicating the relationship of the electrical conductivity and the pH in a case where the carbonic acid concentration in the sample water is zero. Specifically, it is possible to determine that the water quality abnormality in this case is caused by incorporation of a basic substance other than ammonia to the sample water.

In some embodiments, in addition to the above described first correlation map, a second correlation map (see FIG. 4) showing the correlation between the acid electrical conductivity and the pH of the sample water is used to perform water quality diagnosis of circulating water or the like. In the present embodiment, in addition to the measurement value of the electrical conductivity and the measurement value of the pH of the sample water described above, a measurement value of the acid electrical conductivity of the sample water is obtained. It is possible to obtain the measurement value of the acid electrical conductivity of the sample water by, for instance, using the acid electrical conductivity meter 50 of the above described measurement part 40, for instance.

Next, in addition to the above described first determination condition, presence or absence of abnormality of water quality of the steam turbine plant is determined using the second determination condition of whether the measurement value of the acid electrical conductivity and the measurement value of the pH are included in the second determination region set within the second correlation map taking into account the concentration range of ammonia in the sample water assumed in the steam turbine plant.

Now, the second correlation map and the second determination region will be described referring to FIG. 4. The second correlation map is a known map divided as a region where the combination of the acid electrical conductivity and the pH may exist, in relation to the state of water quality of the sample water obtained from the steam turbine plant. It is possible to determine the state of water quality depending on the region to which the measurement values of the electrical conductivity and measurement value of the pH belong on the second correlation map.

In the graph shown in FIG. 4, curves C5 to C7 each indicate a correlation of the acid electrical conductivity (x-axis) and the pH (y-axis) corresponding to the ammonia concentration of the sample water containing ammonia. Specifically, curves C5 to C7 each indicate the correlation of the acid electrical conductivity and the pH when the ammonia concentration in the sample water is 10 ppm, 15 ppm, and 30 ppm, respectively.

The correlation of the electrical conductivity and the pH corresponding to the ammonia concentration (e.g., the relationship indicated by curves C5 to C7 in FIG. 4) is obtained in advance by an experimental method or calculation. In a case of an experimental method, it is possible to obtain the above described correlation by measuring the electrical conductivity and the pH at various ammonia concentrations and carbonic acid concentrations using circulating water in a case where the water quality is normal. In a case of calculation, it is possible to use chemical equilibrium computation to calculate the ammonia concentration and the carbonic acid ion concentration on the basis of acid dissociation equilibrium, alkali dissociation equilibrium, water dissociation equilibrium, balance of positive and negative electric charges, and mass balance of acid and alkali, and then calculate the pH and the electrical conductivity from each of the calculated concentrations.

While the acid electrical conductivity and the pH of the sample water change depending on the carbonic acid concentration of the sample water (circulating water or the like), the relationship between the acid electrical conductivity and the pH follows the correlation indicated by curves C5 to C7. For instance, when the ammonia concentration in the sample water is 30 ppm, the relationship between the acid electrical conductivity and the pH follows curve C7.

Furthermore, the ammonia concentration in the sample water (circulating water or the like) is within the range of approximately not smaller than 10 ppm and not greater than 30 ppm. This is because, in a case where ammonia is used as a water conditioner, ammonia is injected into the feed water such that the pH falls within the range of approximately not smaller than 9.9 and not greater than 10.3 when the carbonic acid concentration is substantially zero, and the ammonia concentration in this case is within the range of approximately not smaller than 10 ppm and not greater than 30 ppm. Thus, the concentration range of ammonia in the sample water assumed in the steam turbine plant using ammonia as a water conditioner is approximately not smaller than 10 ppm and not greater than 30 ppm. In this case, the boundary in a case where the ammonia concentration in the sample water (circulating water or the like) is at a lower limit of the ammonia concentration range of the sample water assumed in a steam turbine plant is shown by curve C5 in FIG. 4, and the boundary in a case of an upper limit is shown by curve C7 in FIG. 4. That is, in FIG. 4, the region between curves C5 and C7 is a region where the combination of the acid electrical conductivity and the pH may exist when there is no water quality abnormality of the sample water (when there is no incorporation of impurity substances or the like).

Thus, by using the above described curves C5 to C7 or the like for instance, it is possible to set a region for water quality abnormality determination (the above described second determination region) taking into account the ammonia concentration range of the sample water assumed for a steam turbine plant, within the second correlation map.

In a steam turbine plant, the concentration of ammonia in the circulating water or the like may change depending on the operation state of the plant, for instance. In this regard, according to the above described embodiment, presence or absence of abnormality of water quality of the sample water (circulating water or the like) is determined on the basis of the second determination condition of whether the measurement value of the acid electrical conductivity and the measurement value of the pH are included in the second determination region which is set within the second correlation map of the acid electrical conductivity and the pH taking into account the concentration range of ammonia in the sample water assumed in a steam turbine plant, in addition to the above described first determination condition. Thus, it is possible to diagnose the water quality appropriately even if the ammonia concentration in the sample water varies depending on the operation condition or the like of the plant.

Furthermore, in a case where salt or acid other than carbonic acid is incorporated into the circulating water or the like, the acid electrical conductivity tends to increase compared to when it is not the case. In this regard, in the above described embodiment, abnormality of the water quality is determined on the basis of whether the measurement value of the acid electrical conductivity and the measurement value of the pH are included in the second determination region in the second correlation map, and thus it is possible to determine abnormality of the water quality more appropriately even if the concentration of acid or salt incorporated in the circulating water or the like is low and it is difficult to determine abnormality of the water quality with the first correlation map of the electrical conductivity and the pH.

In some embodiments, the water quality diagnosis may be performed on the circulating water or the like using the second correlation map (see FIG. 4) showing the correlation between the acid electrical conductivity and the pH of sample water without using the above described first correlation map. In the present embodiment, the measurement value of the acid electrical conductivity and the measurement value of the pH of the sample water described above are obtained. Then, it is possible to determine presence or absence of abnormality of water quality of the steam turbine plant using the second determination condition of whether the measurement value of the acid electrical conductivity and the measurement value of the pH are included in the second determination region set within the second correlation map taking into account the concentration range of ammonia in the sample water assumed in the steam turbine plant.

In some embodiments, presence or absence of abnormality of the water quality is determined on the basis of whether the measurement value of the acid electrical conductivity and the measurement value of the pH of the sample water are included in the second normal region as the second determination region defined on the above described second correlation map. The second normal region defined on the second correlation map may be, for instance, the region B1 (see FIG. 4) between the boundary (curve C5) indicating the relationship of the acid electrical conductivity and the pH in a case where the concentration of ammonia in the sample water is at the lower limit of the above described concentration range (concentration range assumed in a steam turbine plant) and the boundary (curve C7) indicating the relationship of the acid electrical conductivity and the pH in a case where the concentration of ammonia in the sample water is at the upper limit of the above described concentration range.

In the above described embodiment, on the second correlation map, the region B1 between the boundary indicating the relationship of the acid electrical conductivity and the pH in a case where the concentration of ammonia in the sample water is at the lower limit of the above described concentration range and the boundary indicating the relationship of the acid electrical conductivity and the pH in a case where the concentration of ammonia is at the upper limit of the above described concentration range is defined as the second normal region (second determination region). If there is no acid, salt, or alkali incorporated into the circulating water or the like other than carbonic acid, the measurement value of the acid electrical conductivity and the measurement value of the pH of the sample water should be included in the region B1 on the second correlation map. Thus, it is possible to determine presence or absence of abnormality of the water quality appropriately on the basis of whether the measurement value of the acid electrical conductivity and the measurement value of the pH are included in the region B1 (the second normal region).

In an embodiment, it is determined that abnormality of the water quality due to incorporation of acid or salt other than carbonic acid to the sample water is present if, on the second correlation map, the measurement value of the acid electrical conductivity and the measurement value of the pH are included in the region B2 (abnormal region) positioned at an opposite side to the region B1 (the second normal region) as the second determination region across the boundary (curve C7) indicating the relationship of the acid electrical conductivity and the pH in a case where the concentration of ammonia in the sample water is at the upper limit of the above described concentration range.

If acid or salt is incorporated in the circulating water or the like of a steam turbine plant, the acid electrical conductivity tends to increase compared to when it is not the case. In this regard, according to the above described embodiment, it is possible to identify the cause of water quality abnormality if the measurement values are included in the region B2 (abnormality region; i.e., a region where the acid electrical conductivity is relatively high) positioned at an opposite side to the region B1 (the second normal region) across the boundary (curve C7) indicating the relationship of the acid electrical conductivity and the pH in a case where the ammonia concentration is at the upper limit of the concentration range of ammonia assumed in a steam turbine plant on the second correlation map. Specifically, it is possible to determine that the water quality abnormality in this case is caused by incorporation of acid or salt other than carbonic acid to the sample water.

As depicted in FIG. 4, the region B2 (abnormal region) may include a region B2a being a high pH region and a region B2b being a low pH region where the pH is lower than the region B2a (high pH region). In an embodiment, it may be determined that abnormality of the water quality due to incorporation of salt is present if the measurement value of the acid electrical conductivity and the measurement value of the pH of the sample water are included in the above described region B2a (high pH region) on the second correlation map, and it may be determined that abnormality of the water quality due to incorporation of acid other than carbonic acid is present if the measurement value of the acid electrical conductivity and the measurement value of the pH of the sample water are included in the region B2b (low pH region) on the second correlation map.

When salt is incorporated in the circulating water or the like, normally the pH does not change (decrease) compared to when salt is not incorporated. On the other hand, when acid is incorporated in the circulating water or the like, the pH decreases compared to when acid is not incorporated. In this regard, according to the above described embodiment, it is possible to appropriately identify whether the abnormality of the water quality is caused by incorporation of salt or incorporation of acid other than carbonic acid, if the measurement value of the acid electrical conductivity and the measurement value of the pH are included in the above described region B2a (high pH region) or the region B2b (low pH region) on the second correlation map.

In some embodiments, if it is determined that abnormality of the water quality of the steam turbine plant is present by using at least one condition of the first determination condition (determination condition using the first correlation map) or the second determination condition (determination condition using the second correlation map), presence or absence of abnormality of a measurement instrument used to obtain the measurement value of a water quality parameter of the sample water related to the at least one condition is determined. The water quality parameter includes the electrical conductivity, the pH, or the acid electrical conductivity of the sample water. The measurement instrument used for the above water quality parameter is the pH meter 46, the electrical conductivity meter 48, or the acid electrical conductivity meter 50 (ion exchange part 51 and electrical conductivity meter 52) described above, for instance.

If abnormality of the water quality is determined to be present using one condition of the first determination condition or the second determination condition, there is also a possibility of presence of abnormality of the measurement instrument used to measure the water quality parameter (electrical conductivity, acid electrical conductivity, or pH), other than the possibility of actual abnormality of the water quality. In this regard, according to the above described embodiment, if it is determined that abnormality of the water quality is present using one condition of the first determination condition or the second determination condition, presence or absence of abnormality of the measurement instrument used to measure the water quality parameters related to the condition, and thus it is possible to identify whether the abnormality is of the water quality or of the measurement instrument.

In an embodiment, presence or absence of abnormality of the measurement instrument is determined by comparing the measurement value of the water quality parameter of the sample water obtained by a measurement instrument used for determination of the first determination condition or the second determination condition to the measurement value of the water quality parameter of the sample water obtained by a comparative measurement instrument other than the measurement instrument.

According to the above embodiment, if there is a possibility of abnormality of the measurement instrument, it is possible to appropriately determine presence or absence of abnormality of the measurement instrument by comparing the measurement value obtained by a measurement instrument used to measure the water quality parameter related to the first determination condition or the second determination condition to the measurement value obtained by a comparative measurement instrument other than the measurement instrument.

For instance, described below is a case where water quality diagnosis is performed using the first determination condition on the basis of the measurement value of the electrical conductivity and the measurement value of the pH obtained by using feed water obtained from the condenser pump outlet P1 as the sample water and the electrical conductivity meter 48A and the pH meter 46A of the measurement part 40A as measurement instruments. It should be noted that the valves 43A, 44A depicted in FIG. 2 are open and the valve 39 is closed when the electrical conductivity and pH are measured using the electrical conductivity meter 48A and the pH meter 46A of the measurement part 40A.

If it is determined that water quality abnormality is present using the first determination condition, there are both a possibility of abnormality of the water quality of feed water, and a possibility of abnormality of a measurement instrument. So, the electrical conductivity and the pH of the sample water are measured using an electrical conductivity meter 48B and a pH meter 46B of a measurement part 40B being measurement instruments other than the above described measurement instrument (comparative measurement instruments). Specifically, the valve 43B is closed and the valve 39 is opened, so as to guide the feed water (sample water) obtained from the condenser pump outlet P1 to the measurement part 40B, and the electrical conductivity and the pH of the sample water are measured using the electrical conductivity meter 48B and the pH meter 46B as the comparative measurement instruments.

If the difference between the measurement value by the electrical conductivity meter 48A and the measurement value by the electrical conductivity meter 48B is within a predetermined range and the difference between the measurement value by the pH meter 46A and the measurement value by the pH meter 46B is within a predetermined range, it is possible to determine that there is no abnormality of the measurement instruments (the electrical conductivity meter 48A and the pH meter 46A) and there is abnormality of the water quality of the sample water (feed water). If the difference between the measurement value by the electrical conductivity meter 48A and the measurement value by the electrical conductivity meter 48B is not within the predetermined range, it is possible to determine that there is abnormality of the electrical conductivity meter 48A (measurement instrument). If the difference between the measurement value by the pH meter 46A and the measurement value by the pH meter 46B is not within the predetermined range, it is possible to determine that there is abnormality of the pH meter 46A (measurement instrument).

In some embodiments, if it is determined that abnormality of the water quality is present using one condition of the first determination condition or the second determination condition and it is determined that that abnormality of the measurement instrument is absent as a result of determination of presence or absence of abnormality of the measurement instruments, a type of abnormality of the water quality of the steam turbine plant is identified on the basis of the first correlation map or the second correlation map according to the other one of the first determination condition or the second determination condition.

According to the above described embodiment, if it is determined that the abnormality is of the water quality and not of the measurement instruments, it is possible to identify the type of abnormality of the water quality on the basis of the first correlation map or the second correlation map.

In some embodiments, the sample water is obtained from the boiler feed water of the steam turbine plant (e.g., sample water obtained from the low-pressure steam drum P3, the mid-pressure steam drum P4, or the high-pressure steam drum P5), and if it is determined that abnormality of the water quality is present using the first determination condition or the second determination condition, it is identified that the abnormality of the water quality is caused by leakage of sea water at a condenser (e.g., the above described condenser 12) of the steam turbine plant.

According to the above described embodiment, in a case where the sample water is obtained from the boiler feed water, if it is determined that abnormality of the water quality is present, it is identified that the abnormality of the water quality is caused by leakage of sea water at a condenser of the steam turbine plant. That is, since salt like NaCl is incorporated into the feed water to the boiler if there is occurrence of leakage of sea water at a condenser, it is possible to determine that the water quality abnormality of the feed water is caused by leakage of sea water at a condenser.

In some embodiments, the sample water is obtained from the steam of the steam turbine plant (e.g., sample water obtained from the low-pressure steam drum outlet P6, the mid-pressure steam drum outlet P7, or the high-pressure steam drum outlet P8), and if it is determined that abnormality of the water quality is present using the first determination condition or the second determination condition, it is identified that the abnormality of the water quality is caused by droplet entrainment of drum water of the steam turbine plant.

According to the above described embodiment, in a case where the sample water is obtained from steam, if it is determined that abnormality of the water quality is present, it is identified that the abnormality of the water quality is caused by droplet entrainment of drum water of the steam turbine plant. That is, if there is occurrence of droplet entrainment of drum water, acid or salt other than carbonic acid contained in the drum water is incorporated in the steam generated by the drum, and thus it is possible to determine that the water quality abnormality is caused by droplet entrainment of the drum water.

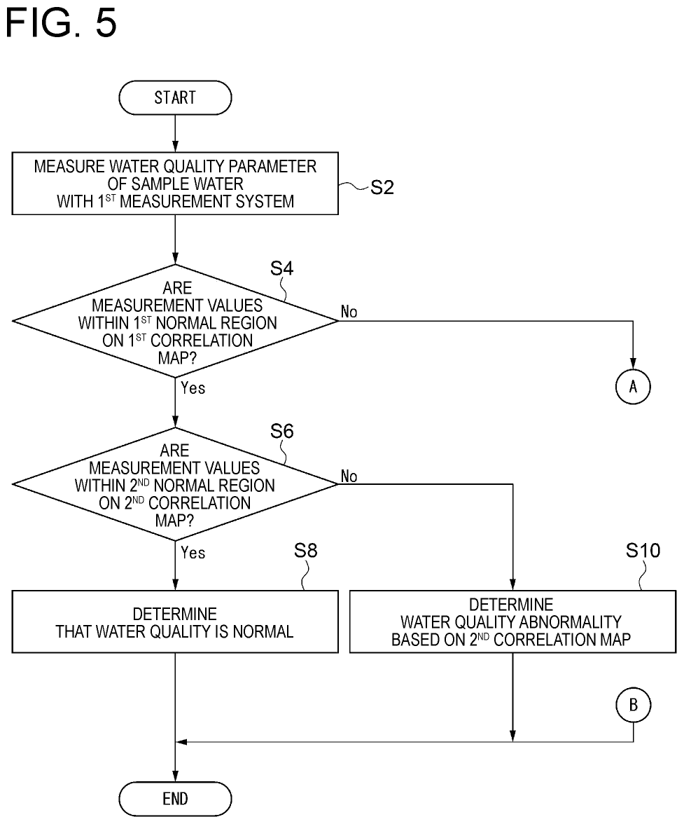

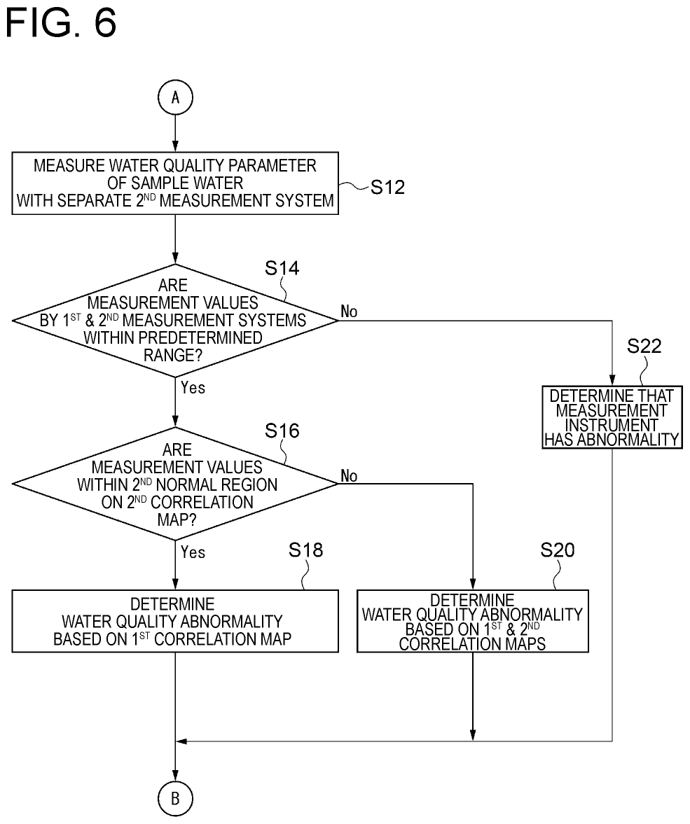

Hereinafter, the specific flow of water quality diagnosis according to an embodiment will be described referring to FIGS. 5 and 6. FIGS. 5 and 6 are each a flowchart of a water quality diagnosis method according to an embodiment. In the following description, described is a case where the water quality diagnosis is performed on the steam turbine plant 1 depicted in FIG. 1 using feed water obtained from the feed water pump outlet P1 as sample water.

The sample water from the feed water pump outlet P1 is guided to the measurement part 40A (first measurement system) depicted in FIG. 2, and the water quality parameter of the sample water is measured using the measurement instrument of the measurement part 40A (the pH meter 46A, the electrical conductivity meter 48A, and the acid electrical conductivity meter 50A). That is, the measurement value of the pH, the measurement value of the electrical conductivity, and the measurement value of the acid electrical conductivity of the sample water are obtained (S2).

Next, it is determined whether the measurement value of the electrical conductivity and the measurement value of the pH obtained in step S2 are included in the region A1 (the first normal region) as the first determination region set within the first correlation map of the electrical conductivity and the pH depicted in FIG. 3.

In step S4, if the measurement value of the electrical conductivity and the measurement value of the pH are not included in the region A1 (the first normal region) (No in step S4), it is determined that there is a possibility of abnormality of the water quality or a possibility of abnormality of the measurement instrument (the electrical conductivity meter 48 or the pH meter 46A) of the measurement part 40A, and the flow advances to step S12 (see FIG. 6).

On the other hand, if the measurement value of the electrical conductivity and the measurement value of the acid electrical conductivity are included in the region A1 (the first normal region) in step S4, it is determined whether the measurement value of the acid electrical conductivity and the measurement value of the pH obtained in step S2 are included in the region B1 (the second normal region) as the second determination region set within the second correlation map of the acid electrical conductivity and the pH shown in FIG. 4 (S6).

In step S6, if the measurement value of the acid electrical conductivity and the measurement value of the pH are included in the region B1 (the second normal region) (that is, if the measurement values of the water quality parameters are included in the normal region in both of the first correlation map and the second correlation map; Yes in step S6), it is determined that the water quality is normal (S8), and the flow ends.

On the other hand, in step S6, if the measurement value of the acid electrical conductivity and the measurement value of the pH are not included in the region B1 (the second normal region) (No in step S6), it is determined that abnormality of the water quality is present (S10), and the flow ends. In S10, the cause of the water quality abnormality may be identified on the basis of the second correlation map. For instance, if the measurement value of the acid electrical conductivity and the measurement value of the pH measured in step S2 are included in the region B2 (abnormal region), it may be determined that abnormality of the water quality caused by incorporation of acid or salt other than carbonic acid to the sample water (feed water) is present. Furthermore, for instance, if the measurement value of the acid electrical conductivity and the measurement value of the pH are included in the region B2a (the high pH region), it may be determined that abnormality of the water quality caused by incorporation of salt to the sample water (feed water) is present. Furthermore, for instance, if the measurement value of the acid electrical conductivity and the measurement value of the pH are included in the region B2b (the low pH region), it may be determined that abnormality of the water quality caused by incorporation of acid other than carbonic acid to the sample water (feed water) is present.

In step S4, if the measurement value of the electrical conductivity and the measurement value of the pH are not included in the region A1 (the first normal region) (No in step S4), in step S12 (see FIG. 6), the sample water from the feed water pump outlet P1 is guided to the measurement part 40B (a second measurement system other than the measurement part 40A (the first measurement system)) depicted in FIG. 2, and the water quality parameters of the sample water are measured using the measurement instruments of the measurement part 40B (the pH meter 46B, the electrical conductivity meter 48B, and the acid electrical conductivity meter 50B; comparative measurement instruments). That is, the measurement value of the pH, the measurement value of the electrical conductivity, and the measurement value of the acid electrical conductivity of the sample water are obtained (S12).

Next, it is determined whether the difference between the measurement values of the water quality parameters by the measurement instruments of the measurement part 40A (first measurement system) and the measurement values of the water quality parameters by the measurement instruments (comparative measurement instruments) of the measurement part 40B (the second measurement system) is within a predetermined range (S14). Specifically, it is determined whether each of the difference between the measurement value by the pH meter 46A and the measurement value by the pH meter 46B, the difference between the measurement value by the electrical conductivity meter 48A and the measurement value by the electrical conductivity meter 48B, and the difference between the measurement value by the acid electrical conductivity meter 50A and the measurement value by the acid electrical conductivity meter 50B is within a predetermined range.

In step S14, if the difference of the measurement values by any of the measurement instruments is not within the predetermined range (No in step S14), it is determined that abnormality of the measurement instrument (the pH meter 46A, the electrical conductivity meter 48A, or the acid electrical conductivity meter 50A) of the measurement part 40A (first measurement system) is present (S22), and the flow ends. The step S22 may include determining which of the pH meter 46A, the electrical conductivity meter 48A or the acid electrical conductivity meter 50A has abnormality. That is, in step S14, it may be determined that there is abnormality of the measurement instrument whose measurement value difference is not within the predetermined range.

On the other hand, in step S14, if the difference of the measurement values by each measurement instrument is within the predetermined range (Yes in S14), it is determined that abnormality of the measurement instrument (the pH meter 46A, the electrical conductivity meter 48A, or the acid electrical conductivity meter 50A) is absent, and the flow advances to step S16.

In step S16, it is determined whether the measurement value of the acid electrical conductivity and the measurement value of the pH obtained in step S2 are included in the region B1 (the second normal region) as the second determination region set within the second correlation map of the acid electrical conductivity and the pH depicted in FIG. 4 (S16).

In step S16, if the measurement value of the acid electrical conductivity and the measurement value of the pH are included in the region B1 (the second normal region) (Yes in step S16), it is determined that abnormality of the water quality is present on the basis of the first correlation map (S18), and the flow ends. In step S18, the cause of the water quality abnormality may be identified on the basis of the first correlation map. For instance, if the measurement value of the electrical conductivity and the measurement value of the pH measured in step S2 are included in the region A2, it may be determined that abnormality of water quality caused by incorporation of acid or salt other than carbonic acid to the sample water (feed water) is present. Furthermore, for instance, if the measurement value of the electrical conductivity and the measurement value of the pH are included in the region A3, it may be determined that abnormality of the water quality caused by incorporation of a basic substance other than ammonia to the sample water (feed water) is present.

On the other hand, in step S16, if the measurement value of the acid electrical conductivity and the measurement value of the pH are not included in the region B1 (the second normal region) (that is, if the measurement values of the water quality parameters are included in the abnormal region in both of the first correlation map and the second correlation map; No in step S16), it is determined that abnormality of the water quality is present on the basis of the first correlation map and the second correlation map (S20), and the flow ends. In step S20, the cause of the water quality abnormality may be identified on the basis of the first correlation map and the second correlation map. For instance, if the measurement value of the electrical conductivity and the measurement value of the pH measured in step S2 are included in the region A2, and the measurement value of the acid electrical conductivity and the measurement value of the pH measured in step S2 are included in the region B2a, it may be determined that abnormality of water quality caused by incorporation of salt to the sample water (feed water) is present. Furthermore, for instance, if the measurement value of the acid electrical conductivity and the measurement value of the pH are included in the region A2, and the measurement value of the acid electrical conductivity and the measurement value of the pH are included in the region B2b, it may be determined that abnormality of the water quality caused by incorporation of acid other than carbonic acid to the sample water (feed water) is present. Furthermore, for instance, if the measurement value of the electrical conductivity and the measurement value of the pH are included in the region A3, it may be determined that abnormality of the water quality caused by incorporation of a basic substance other than ammonia to the sample water (feed water) is present.

The contents described in the above respective embodiments can be understood as follows, for instance.
(1) According to at least one embodiment of the present invention, a water quality diagnosis method includes: a step (e.g., the above described step S2) of obtaining a measurement value of electrical conductivity of a sample water derived from a steam or a circulating water obtained from a steam turbine plant (1) using ammonia as a water conditioner and a measurement value of pH of the sample water; and a determination step (e.g., the above described step S4) of determining presence or absence of abnormality of water quality of the steam turbine plant by using at least a first determination condition of whether the measurement value of the electrical conductivity and the measurement value of the pH are included in a first determination region which is set within a first correlation map of the electrical conductivity and the pH taking into account a carbonic acid concentration range where carbonic acid is dissolvable in the sample water.
As described above, the correlation between the electrical conductivity and the pH of the circulating water or the like is under influence of the carbonic acid concentration in water. In this regard, according to the above method (1), presence or absence of abnormality of the water quality of the sample water (circulating water or the like) is determined on the basis of the first determination condition of whether the measurement value of the electrical conductivity and the measurement value of the pH are included in the first determination region which is set within the first correlation map of the electrical conductivity and the pH taking into account a carbonic acid concentration at which carbonic acid is dissolvable in the sample water. Thus, it is possible to diagnose the water quality appropriately even if the carbonic acid concentration in the sample water varies depending on the operation state or the like of the plant.
(2) In some embodiments, in the above method (1), presence or absence of abnormality of the water quality is determined on the basis of whether the measurement value of the electrical conductivity and the measurement value of the pH are included in a first normal region defined on the first correlation map as a region (e.g., the above described region A1) between a boundary indicating a relationship of the electrical conductivity and the pH in a case where a carbonic acid concentration in the sample water is zero and a boundary indicating a relationship of the electrical conductivity and the pH in a case where the carbonic acid concentration is at an upper limit where carbonic acid is dissolvable in the sample water, the first normal region being the first determination region.
In the above method (2), on the first correlation map, the region between the boundary indicating the relationship of the electrical conductivity and the pH in a case where the carbonic acid concentration in the sample water is zero and the boundary indicating the relationship of the electrical conductivity and the pH in a case where the carbonic acid concentration in the sample water is at an upper limit is defined as the first normal region (first determination region). Thus, it is possible to determine presence or absence of abnormality of the water quality appropriately on the basis of whether the measurement value of the electrical conductivity and the measurement value of the pH are included in the first normal region.
(3) In some embodiments, in the above method (2), it is determined that abnormality of the water quality due to incorporation of acid or salt other than carbonic acid to the sample water is present if, on the first correlation map, the measurement value of the electrical conductivity and the measurement value of the pH are included in a region (e.g., the above described region A2) positioned at an opposite side to the first normal region across the boundary indicating the relationship of the electrical conductivity and the pH in a case where the carbonic acid concentration is at the upper limit where carbonic acid is dissolvable in the sample water.
If acid or salt is incorporated in the circulating water or the like of a steam turbine plant, the pH tends to decrease or the electrical conductivity tends to increase compared to when it is not the case. According to the above method (3), it is possible to identify the cause of water quality abnormality if the measurement value of the electrical conductivity and the measurement value of the pH are included in the region at an opposite side to the first normal region across the boundary indicating the relationship of the electrical conductivity and the pH in a case where the carbonic acid concentration is at the upper limit. Specifically, it is possible to determine that the water quality abnormality is caused by incorporation of acid or salt other than carbonic acid to the sample water.
(4) In some embodiments, in the above method (2) or (3), it is determined that abnormality of the water quality due to incorporation of a basic substance other than ammonia is present if, on the first correlation map, the measurement value of the electrical conductivity and the measurement value of the pH are included in a region (e.g., the above described region A3) positioned at an opposite side to the first normal region across the boundary indicating the relationship of the electrical conductivity and the pH in a case where the carbonic acid concentration is zero.
If a basic substance is incorporated in a steam turbine plant, the pH tends to increase compared to when it is not the case. According to the above method (4), it is possible to identify the cause of water quality abnormality if the measurement value of the electrical conductivity and the measurement value of the pH are included in a region at an opposite side to the first normal region across the boundary indicating the relationship of the electrical conductivity and the pH in a case where the carbonic acid concentration is zero. Specifically, it is possible to determine that the water quality abnormality in this case is caused by incorporation of a basic substance other than ammonia to the sample water.
(5) In some embodiments, any one of the above methods (1) to (4) includes a step (e.g., the above described step S2) of obtaining a measurement value of acid electrical conductivity of the sample water and, in addition to the first determination condition, presence or absence of abnormality of the water quality is determined by using a second determination condition of whether the measurement value of the acid electrical conductivity and the measurement value of the pH are included in a second determination region which is set within a second correlation map of the acid electrical conductivity and the pH taking into account a concentration range of ammonia in the sample water assumed in the steam turbine plant (e.g., the above described steps S6, S16).
In a steam turbine plant, the water quality of circulating water or the like may change due to incorporation of acid, alkali, or salt from outside, and such a change in the water quality may also cause change in the acid electrical conductivity and the pH of the circulating water or the like. Furthermore, the correlation between the acid electrical conductivity and the pH of the circulating water or the like is under influence of the concentration of ammonia in the water. The concentration of ammonia in the circulating water or the like may change depending on the operation state of the plant, for instance. According to the above method (5), presence or absence of abnormality of the water quality of the sample water (circulating water or the like) is determined on the basis of the second determination condition of whether the measurement value of the acid electrical conductivity and the measurement value of the pH are included in the second determination region which is set within the second correlation map of the acid electrical conductivity and the pH taking into account a concentration range of ammonia in the sample water assumed in a steam turbine plant, in addition to the above described first determination condition. Thus, it is possible to diagnose the water quality appropriately even if the ammonia concentration in the sample water varies due to the operation state or the like of the plant.
Furthermore, in a case where salt or acid other than carbonic acid is incorporated into the circulating water or the like, the acid electrical conductivity (that is, electrical conductivity measured after exchanging the cations into hydrogen ions) of the sample water tends to increase compared to when it is not the case. In this regard, according to the above method (5), abnormality of the water quality is determined on the basis of whether the measurement value of the acid electrical conductivity and the measurement value of the pH are included in the second determination region in the second correlation map, and thus it is easier to determine abnormality of the water quality more appropriately even if the concentration of acid or salt incorporated in the circulating water or the like is low and it is difficult to determine abnormality of the water quality with the first correlation map of the electrical conductivity and the pH.
(6) In some embodiments, in the above method (5), presence or absence of abnormality of the water quality is determined on the basis of whether the measurement value of the acid electrical conductivity and the measurement value of the pH are included in a second normal region (e.g., the above described region B1) which is defined on the second correlation map as a region between a boundary indicating a relationship between the acid electrical conductivity and the pH in a case where a concentration of ammonia in the sample water is at a lower limit of the concentration range and a boundary indicating a relationship of the acid electrical conductivity and the pH in a case where the concentration of ammonia in the sample water is at an upper limit of the concentration range, the second normal region being the second determination region.
According to the above method (6), on the second correlation map, the region between the boundary indicating the relationship of the acid electrical conductivity and the pH in a case where the concentration of ammonia in the sample water is at the lower limit of the above described concentration range and the boundary indicating the relationship of the acid electrical conductivity and the pH in a case where the concentration of ammonia is at the upper limit of the above described concentration range is defined as the second normal region (second determination region). Thus, it is possible to determine presence or absence of abnormality of the water quality appropriately on the basis of whether the measurement value of the acid electrical conductivity and the measurement value of the pH are included in the second normal region.
(7) In some embodiments, in the above method (6), it is determined that abnormality of the water quality due to incorporation of acid or salt other than carbonic acid to the sample water is present if, on the second correlation map, the measurement value of the acid electrical conductivity and the measurement value of the pH are included in an abnormal region (e.g., the above described region B2) positioned at an opposite side to the second normal region across the boundary indicating the relationship of the acid electrical conductivity and the pH in a case where the concentration of ammonia in the sample water is at the upper limit of the concentration range.
According to the above described embodiment (7), it is possible to identify the cause of water quality abnormality if, on the second correlation map, the measurement values are included in the abnormality region (i.e., a region where the acid electrical conductivity is relatively high) positioned at an opposite side to the second normal region across the boundary indicating the relationship of the acid electrical conductivity and the pH in a case where the ammonia concentration is at the upper limit of the concentration range of ammonia assumed in a steam turbine plant. Specifically, it is possible to determine that the water quality abnormality in this case is caused by incorporation of acid or salt other than carbonic acid to the sample water.
(8) In some embodiments, in the above method (7), the abnormal region includes a high pH region (e.g., the above described region B2a) and a low pH region (e.g., the above described region B2b) where the pH is lower than the high pH region. It is determined that abnormality of the water quality due to incorporation of salt is present if the measurement value of the acid electrical conductivity and the measurement value of the pH are included in the high pH region on the second correlation map, and it is determined that abnormality of the water quality due to inclusion of acid is present if the measurement value of the acid electrical conductivity and the measurement value of the pH are included in the low pH region on the second correlation map.
When acid is incorporated into the circulating water or the like, the pH of the circulating water or the like decreases. On the other hand, when salt is incorporated into the circulating water or the like, the pH of the circulating water or the like does not change (decrease) considerably. In this regard, according to the above method (8), it is possible to identify whether the abnormality of the water quality is caused by incorporation of salt or incorporation of acid other than carbonic acid on the basis of whether the measurement value of the acid electrical conductivity and the measurement value of the pH are included in the high pH region or the low pH region on the second correlation map.
(9) In some embodiments, any one of the above methods (6) to (8) further includes a step (e.g., the above described step S14) of determining, if it is determined that abnormality of the water quality is present by using at least one condition of the first determination condition or the second determination condition, presence or absence of abnormality of a measurement instrument used to obtain the measurement value of a water quality parameter of the sample water related to the at least one condition, and the water quality parameter includes electrical conductivity, pH, or acid electrical conductivity of the sample water.
If abnormality of the water quality is determined to be present using one condition of the first determination condition or the second determination condition, there is also a possibility of presence of abnormality of the measurement instrument used to measure the water quality parameter (electrical conductivity, acid electrical conductivity, or pH), other than the possibility of actual abnormality of the water quality. In this regard, according to the above method (9), if it is determined that abnormality of the water quality is present using one condition of the first determination condition or the second determination condition, presence or absence of abnormality of the measurement instrument used to measure the water quality parameters related to the condition is determined, and thus it is possible to identify whether the abnormality is of the water quality or of the measurement instrument.
(10) In some embodiments, in the above method (9), presence or absence of abnormality of the measurement instrument is determined by comparing the measurement value of the water quality parameter of the sample water obtained by the measurement instrument to a measurement value of the water quality parameter of the sample water obtained by a comparative measurement instrument other than the measurement instrument.
According to the above method (10), if there is a possibility of abnormality of the measurement instrument, it is possible to appropriately determine presence or absence of abnormality of the measurement instrument by comparing the measurement value obtained by a measurement instrument used to measure the water quality parameter for determination of the first determination condition or the second determination condition to the measurement value obtained by a comparative measurement instrument other than the measurement instrument.
(11) In some embodiments, in the above method (9) or (10), if it is determined that abnormality of the measurement instrument is absent, a type of abnormality of the water quality of the steam turbine plant is identified on the basis of the first correlation map or the second correlation map according to the other one of the first determination condition or the second determination condition.
According to the above method (11), if it is determined that the abnormality is not of the water quality but of the measurement instruments, it is possible to identify the type of abnormality of the water quality on the basis of the first correlation map or the second correlation map.
(12) In some embodiments, in any one of the above methods (1) to (11) in a case where the sample water is obtained from a boiler feed water of the steam turbine plant, if it is determined that abnormality of the water quality is present in the determination step, it is identified that the abnormality of the water quality is caused by leakage of a sea water at a condenser of the steam turbine plant.
According to the above method (12), in a case where the sample water is obtained from the boiler feed water, if it is determined that abnormality of the water quality is present, it is identified that the abnormality of the water quality is caused by leakage of sea water at a condenser of the steam turbine plant. That is, since salt like NaCl is incorporated into the feed water to the boiler if there is occurrence of leakage of sea water at a condenser, it is possible to determine that the water quality abnormality of the feed water is caused by leakage of sea water at a condenser.
(13) In some embodiments, in any one of the above methods (1) to (11), in a case where the sample water is obtained from a steam of the steam turbine plant, if it is determined that abnormality of the water quality is present in the determination step, it is identified that the abnormality of the water quality is caused by droplet entrainment of a drum water of the steam turbine plant.
According to the above method (13), in a case where the sample water is obtained from steam, if it is determined that abnormality of the water quality is present, it is identified that the abnormality of the water quality is caused by droplet entrainment of drum water of the steam turbine plant. That is, if there is occurrence of droplet entrainment of drum water, acid or salt other than carbonic acid contained in the drum water is incorporated in the steam generated by the drum, and thus it is possible to determine that the water quality abnormality is caused by droplet entrainment of the drum water.
(14) In some embodiments, in any one of the above methods (1) to (13), the sample water is obtained from a boiler feed water at a condenser pump outlet (P1), a boiler feed water at a low-pressure economizer inlet (P2), a drum water of a low-pressure steam drum (P3), a drum water of a mid-pressure steam drum (P4), a drum water of a high-pressure steam drum (P5), a steam at a low-pressure steam drum outlet (P6), a steam at a mid-pressure steam drum outlet (P7), or a steam at a high-pressure steam drum outlet (P8) of the steam turbine plant.
According to the above method (14), by using the sample water obtained from circulating water (feed water or drum water) or steam at the above described position of the steam turbine plant, it is possible to appropriately determine water quality abnormality of the circulating water or steam at the position.
(15) According to at least one embodiment of the present invention, a water quality diagnosis method includes: a step (e.g., the above described step S2) of obtaining a measurement value of acid electrical conductivity of sample water derived from a steam or a circulating water obtained from a steam turbine plant using ammonia as a water conditioner and a measurement value of pH of the sample water, a step (e.g., the above described step S16) of determining presence or absence of abnormality of water quality of the steam turbine plant by using at least a second determination condition of whether the measurement value of the acid electrical conductivity and the measurement value of the pH are included in a second determination region which is set within a second correlation map of the acid electrical conductivity and the pH taking into account a concentration range of ammonia in the sample water assumed in the steam turbine plant.
In a steam turbine plant, the water quality of circulating water or the like may change due to incorporation of acid, alkali, or salt from outside, and such a change in the water quality may also cause change in the acid electrical conductivity and the pH of the circulating water or the like. Furthermore, the correlation between the acid electrical conductivity and the pH of the circulating water or the like is under influence of the concentration of ammonia in the water. The concentration of ammonia in the circulating water or the like may change depending on the operation state of the plant, for instance. According to the above method (15), presence or absence of abnormality of water quality of the sample water (circulating water or the like) is determined on the basis of the second determination condition of whether the measurement value of the acid electrical conductivity and the measurement value of the pH are included in the second determination region which is set within the second correlation map of the acid electrical conductivity and the pH taking into account a concentration range of ammonia in the sample water assumed in a steam turbine plant. Thus, it is possible to diagnose the water quality appropriately even if the ammonia concentration in the sample water varies due to the operation state or the like of the plant.

Embodiments of the present invention were described in detail above, but the present invention is not limited thereto, and various amendments and modifications may be implemented.

Further, in the present specification, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### REFERENCE SIGNS LIST

1 Steam turbine pant
2 Boiler
3 Feed water line
4 Feed water pump
6 Grand steam condenser
8 Steam turbine
10 High-mid-pressure feed water pump
12 Condenser
13 High-pressure economizer
14 High-pressure drum
16 High-pressure superheater
18 Reheater
20 Mid-pressure economizer
22 Mid-pressure drum
24 Mid-pressure superheater
26 Low-pressure economizer
28 Low-pressure drum
30 Low-pressure superheater
38 Connection line
39 Valve
40A, 40B Measurement part
42, 42A, 42B Sample water supply line
43, 43A, 43B Valve
44, 44A, 44B Valve
46, 46A, 46B pH meter
48, 48A, 48B Electrical conductivity meter
50,50A,50B Acid electrical conductivity meter
51 Ion exchange part
52 Electrical conductivity meter
54 Sample water discharge line
60 Agent supply part
62 Agent tank
64 Agent line
66 Agent pump
P1 to P8 Obtaining point

1. A water quality diagnosis method, comprising:
a step of obtaining a measurement value of electrical conductivity of a sample water derived from a steam or a circulating water obtained from a steam turbine plant using ammonia as a water conditioner and a measurement value of pH of the sample water; and
a determination step of determining presence or absence of abnormality of water quality of the steam turbine plant by using at least a first determination condition of whether the measurement value of the electrical conductivity and the measurement value of the pH are included in a first determination region which is set within a first correlation map of the electrical conductivity and the pH taking into account a carbonic acid concentration range where carbonic acid is dissolvable in the sample water.

2. The water quality diagnosis method according to claim 1,
wherein presence or absence of abnormality of the water quality is determined on the basis of whether the measurement value of the electrical conductivity and the measurement value of the pH are included in a first normal region defined on the first correlation map as a region between a boundary indicating a relationship of the electrical conductivity and the pH in a case where a carbonic acid concentration in the sample water is zero and a boundary indicating a relationship of the electrical conductivity and the pH in a case where the carbonic acid concentration is at an upper limit where carbonic acid is dissolvable in the sample water, the first normal region being the first determination region.

3. The water quality diagnosis method according to claim 2,
wherein it is determined that abnormality of the water quality due to incorporation of acid or salt other than carbonic acid to the sample water is present if, on the first correlation map, the measurement value of the electrical conductivity and the measurement value of the pH are included in a region positioned at an opposite side to the first normal region across the boundary indicating the relationship of the electrical conductivity and the pH in a case where the carbonic acid concentration is at the upper limit where carbonic acid is dissolvable in the sample water.

4. The water quality diagnosis method according to claim 2,
wherein it is determined that abnormality of the water quality due to incorporation of a basic substance other than ammonia is present if, on the first correlation map, the measurement value of the electrical conductivity and the measurement value of the pH are included in a region positioned at an opposite side to the first normal region across the boundary indicating the relationship of the electrical conductivity and the pH in a case where the carbonic acid concentration is zero.

5. The water quality diagnosis method according to claim 1,
further comprising a step of obtaining a measurement value of acid electrical conductivity of the sample water,
wherein, in addition to the first determination condition, presence or absence of abnormality of the water quality is determined by using a second determination condition of whether the measurement value of the acid electrical conductivity and the measurement value of the pH are included in a second determination region which is set within a second correlation map of the acid electrical conductivity and the pH taking into account a concentration range of ammonia in the sample water assumed in the steam turbine plant.

6. The water quality diagnosis method according to claim 5,
wherein presence or absence of abnormality of the water quality is determined on the basis of whether the measurement value of the acid electrical conductivity and the measurement value of the pH are included in a second normal region which is defined on the second correlation map as a region between a boundary indicating a relationship between the acid electrical conductivity and the pH in a case where a concentration of ammonia in the sample water is at a lower limit of the concentration range and a boundary indicating a relationship of the acid electrical conductivity and the pH in a case where the concentration of ammonia in the sample water is at an upper limit of the concentration range, the second normal region being the second determination region.

7. The water quality diagnosis method according to claim 6,
wherein it is determined that abnormality of the water quality due to incorporation of acid or salt other than carbonic acid to the sample water is present if, on the second correlation map, the measurement value of the acid electrical conductivity and the measurement value of the pH are included in an abnormal region positioned at an opposite side to the second normal region across the boundary indicating the relationship of the acid electrical conductivity and the pH in a case where the concentration of ammonia in the sample water is at the upper limit of the concentration range.

8. The water quality diagnosis method according to claim 7,
wherein the abnormal region includes a high pH region and a low pH region where the pH is lower than the high pH region,
wherein it is determined that abnormality of the water quality due to incorporation of the salt is present if the measurement value of the acid electrical conductivity and the measurement value of the pH are included in the high pH region on the second correlation map, and
wherein it is determined that abnormality of the water quality due to inclusion of the acid is present if the measurement value of the acid electrical conductivity and the measurement value of the pH are included in the low pH region on the second correlation map.

9. The water quality diagnosis method according to claim 6,
further comprising a step of determining, if it is determined that abnormality of the water quality is present by using at least one condition of the first determination condition or the second determination condition, presence or absence of abnormality of a measurement instrument used to obtain the measurement value of a water quality parameter of the sample water related to the at least one condition,
wherein the water quality parameter includes electrical conductivity, pH, or acid electrical conductivity of the sample water.

10. The water quality diagnosis method according to claim 9,
wherein presence or absence of abnormality of the measurement instrument is determined by comparing the measurement value of the water quality parameter of the sample water obtained by the measurement instrument to a measurement value of the water quality parameter of the sample water obtained by a comparative measurement instrument other than the measurement instrument.

11. The water quality diagnosis method according to claim 9,
wherein, if it is determined that abnormality of the measurement instrument is absent, a type of abnormality of the water quality of the steam turbine plant is identified on the basis of the first correlation map or the second correlation map according to the other one of the first determination condition or the second determination condition.

12. The water quality diagnosis method according to claim 1,
wherein, in a case where the sample water is obtained from a boiler feed water of the steam turbine plant, if it is determined that abnormality of the water quality is present in the determination step, it is identified that the abnormality of the water quality is caused by leakage of a sea water at a condenser of the steam turbine plant.

13. The water quality diagnosis method according to claim 1,
wherein, in a case where the sample water is obtained from a steam of the steam turbine plant, if it is determined that abnormality of the water quality is present in the determination step, it is identified that the abnormality of the water quality is caused by droplet entrainment of a drum water of the steam turbine plant.

14. The water quality diagnosis method according to claim 1,
wherein the sample water is obtained from a boiler feed water at a condenser pump outlet, a boiler feed water at a low-pressure economizer inlet, a drum water of a low-pressure steam drum, a drum water of a mid-pressure steam drum, a drum water of a high-pressure steam drum, a steam at a low-pressure steam drum outlet, a steam at a mid-pressure steam drum outlet, or a steam at a high-pressure steam drum outlet of the steam turbine plant.

15. A water quality diagnosis method, comprising:
a step of obtaining a measurement value of acid electrical conductivity of sample water derived from a steam or a circulating water obtained from a steam turbine plant using ammonia as a water conditioner and a measurement value of pH of the sample water; and
a step of determining presence or absence of abnormality of water quality of the steam turbine plant by using at least a second determination condition of whether the measurement value of the acid electrical conductivity and the measurement value of the pH are included in a second determination region which is set within a second correlation map of the acid electrical conductivity and the pH taking into account a concentration range of ammonia in the sample water assumed in the steam turbine plant.
